(19) United States
(12) Patent Application Publication
(10) Pub. No.: US 2006/0128885 A1
(43) Pub. Date: Jun. 15, 2006

(54) High-solids polyurethane-polyurea dispersions

(76) Inventors: Thorsten Rische, Unna (DE); Gerald Kurek, Leverkusen (DE); Holger Casselmann, Odenthal (DE); Thomas Feller, Solingen (DE); Thomas Munzmay, Dormagen (DE); Detlef-Ingo Schutze, Odenthal (DE); Harald Blum, Leverkusen (DE); Hans-Georg Muller, Leverkusen (DE)

Correspondence Address: BAYER MATERIAL SCIENCE LLC, 100 BAYER ROAD, PITTSBURGH, PA, 15205, US

(21) Appl. No.: 11/298,345

(22) Filed: Dec. 8, 2005

(30) Foreign Application Priority Data
Dec. 13, 2004 (DE) 102004060139.9

(51) Int. Cl. C08G 18/08

(52) U.S. Cl. 524/589

(57) ABSTRACT

The present invention relates to aqueous polyurethane-polyurea dispersions having two discrete maxima in the particle size distribution, wherein the maximum of the fine fraction is between 51 and 150 nm and the maximum of the coarse fraction is between 160 and 700 nm. The present invention also relates to a process for preparing the polyurethane-polyurea dispersions, to coating compositions containing these polyurethane-polyurea dispersions, and to coated substrates prepared from these coating compositions.

### BACKGROUND OF THE INVENTION

1. Field of the Invention

The present invention relates to bimodal, high-solids polyurethane dispersions, a process for their preparation and use.

2. Description of Related Art

Substrates are increasingly being coated using aqueous binders, especially polyurethane-polyurea (PU) dispersions. The preparation of aqueous PU dispersions is known. In contrast to many other classes of aqueous binders, PU dispersions are notable in particular for high resistance to chemicals and water, high mechanical strength, and a high tensile strength and elongation. These requirements are largely met by the polyurethane-polyurea dispersions of the prior art. The systems specified therein may, as a result of hydrophilic groups, be self-emulsifying, i.e., they may be dispersed in water without the aid of external emulsifiers, and possess a monomodal particle size distribution. So that the viscosity of these dispersions remains within a range which is acceptable for performance concerns, they are usually available commercially with solids contents of between 30% and 45% by weight solids. For numerous fields of use in the coating sector, however, it would be desirable to have PU dispersions having significantly higher solids contents. Such dispersions would be able, for example, to simplify application operations (producing thicker films in one coat) and to open up access to entirely new applications or fields of application.

A disadvantage of the high-solids PU dispersions of the prior art is that in many cases they do not satisfy the requirements necessary for their use. They are generally stabilized with large amounts of external emulsifiers, and possess broadly distributed monomodal particle size distributions and high average particle sizes. They can therefore be protected against sedimentation only through the use of thickeners. The property profiles of these high-solids dispersions are therefore well below the level required.

From the prior art it is known that bimodal dispersions have two separate maxima in their particle size distribution, and the bimodality is one way of increasing the solids content of dispersions. In comparison, monodisperse systems, containing only small or only large polymer particles, lead only to low solids contents, due to the viscosity problem.

U.S. Pat. No. 4,474,860 and U.S. Pat. No. 4,567,099 describe high-solids bimodal styrene/butadiene latices having an exactly bimodal particle size distribution and a low viscosity. Polyurethane-polyurea dispersions, in contrast, are not disclosed.

WO-A 02/070615 describes bimodal aqueous polymer dispersions having two discrete particle size maxima. The examples exclusively describe the preparation of primary polyacrylate dispersions with a bimodal particle size distribution. The bimodality is produced in two stages, and the resultant products are especially suitable for paper coating.

In a paper given at the International Waterborne, High Solids and Powder Coatings Symposium 2004 in New Orleans, on the topic “A detailed understanding of Polyurethane Dispersions, their process and applications”, B. Erdem et al. describe a process for preparing high-solids dispersions by using external surface-active substances in a continuous preparation operation. Polyurethane dispersions containing external hydrophilic substances, however, frequently fail to satisfy the exacting requirements of paints and coating compositions or adhesives. Moreover, this operation does not allow the specific preparation of bimodal dispersions. The incorporation of hard segment structural units in relatively large amounts is likewise not possible, since the viscosities which can be handled with this process are very limited.

An object of the present invention is to provide polyurethane-polyurea (PU) dispersions which combine a high solids content with low viscosity and which are not stabilized via external emulsifiers.

It has now surprisingly been found that by keeping to a defined ratio of particle sizes it is possible to obtain low-viscosity PU dispersions which overcome the disadvantages of the prior art.

The size of the large and of the small particles in the bimodal dispersion must be chosen and matched to one another in such a way that the coating composition combines high solids with a low viscosity. If the particles are too small, the solids content drops and/or the viscosity increases; if particles are too large, the viscosity goes up and the performance properties and stability are no longer sufficient.

### SUMMARY OF THE INVENTION

The present invention relates to aqueous polyurethane-polyurea dispersions having two discrete maxima in the particle size distribution, wherein the maximum of the fine fraction is between 51 and 150 nm and the maximum of the coarse fraction is between 160 and 700 nm.

The present invention also relates to a process for preparing the polyurethane-polyurea dispersions of the invention by reacting at an equivalent ratio of isocyanate groups to isocyanate-reactive groups of 1.0 to 3.5, components selected from
I.1) polyisocyanates,
I.2) polyols having number average molecular weights of 200 to 8000 g/mol,
I.3) low molecular weight compounds having a number average molecular weight of 62 to 400 and containing in total two or more hydroxyl and/or amino groups,
I.4) compounds containing one hydroxyl or amino group,
I.5) isocyanate-reactive, ionic or potential ionic hydrophilic compounds, and
I.6) isocyanate-reactive, nonionic hydrophilic compounds,
   to form an isocyanate-functional prepolymer free of urea groups, and subsequently reacting the remaining isocyanate groups with chain extension or chain termination before, during or after dispersing in water, wherein the amount of ═N⁺═, ═S⁺—, —COO⁻ or —SO₃⁻ or PO₃²⁻ groups is 0.1 to 15 milliequivalent per 100 g of resin solids, with amino-functional compounds selected from I.3) to I.6) at an equivalent ratio of amino groups to free isocyanate groups of 40% to 150%.

The present invention also relates to coating compositions containing the polyurethane-polyurea dispersions of the invention.

The present invention also relates to coated substrates prepared from coating compositions containing polyurethane-polyurea dispersions.

### DETAILED DESCRIPTION OF THE INVENTION

The aqueous polyurethane-polyurea dispersions of the present invention have two discrete maxima in the particle size distribution, wherein the maximum of the fine fraction is between 51 and 150 nm, preferably between 55 and 145 nm, and the maximum of the coarse fraction is between 160 and 700 nm, preferably between 200 and 700 nm. The polyurethane particles of the fine fraction have a particle size of 1 to 300 nm, preferably 5 to 300 nm and more preferably 10 to 275 nm. The polyurethane particles of the coarse fraction have a particle size of 100 to 1500 nm, preferably 125 to 1250 and more preferably 160 to 1000 nm. With regard to the preceding particle sizes, in any one particular polyurethane-polyurea dispersion the smallest particle size of the coarse fraction is greater than the largest particle size of the fine fraction.

The bimodal PU dispersions contain a fine fraction of 10% to 50%, preferably 15% to 45% and more preferably 20% to 40% by weight and a coarse fraction of between 50% to 90%, preferably 55% to 85% and more preferably 60% to 80% by weight, the sum of the weight fractions of coarse and fine fraction adding up to 100% by weight. The bimodal PU dispersions of the invention have a viscosity of 1 to 1500 mPa·s, preferably 10 to 750 mPa·s and more preferably 10 to 500 mPa·s.

The particles of the fine fraction and coarse fraction differ significantly in terms of their charges per mass. The fine fraction carries a total surface charge of 50 to 750 μeq/g resin solids, preferably of 50 to 700 μeq/g resin solids and more preferably of 50 to 650 μeq/g resin solids. The coarse fraction possesses a surface charge of 1 to 300 μeq/g resin solids, preferably 10 to 250 μeq/g resin solids and more preferably 10 to 200 μeq/g resin solids, with the difference in surface charge between fine fraction and coarse fraction being 10 to 500 μeq/g resin solids, preferably 20 to 450 μeq/g resin solids and more preferably 20 to 400 μeq/g.

In the process for preparing the polyurethane-polyurea dispersions of the invention components I.1) to I.6) are initially reacted at an equivalent ratio of isocyanate groups to isocyanate-reactive groups of 1.0 to 3.5, preferably 1.1 to 3.0 and more preferably 1.1 to 2.5, to form an isocyanate-functional prepolymer free of urea groups. The remaining isocyanate groups are reacted with chain extension or chain termination before, during or after dispersing in water, with amino-functional compounds selected from I.3) to I.6) at an equivalent ratio of amino groups to free isocyanate groups of 40% to 150%, preferably 50% to 120% and more preferably 60% to 120%.

Suitable polyisocyanates of component I.1) are the aromatic, araliphatic, aliphatic or cycloaliphatic polyisocyanates with an NCO functionality of ≧2 which are known to the skilled man.

Examples of such suitable polyisocyanates are 1,4-butylene diisocyanate, 1,6-hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or mixtures thereof with any desired isomer content, 1,4-cyclohexylene diisocyanate, 1,4-phenylene diisocyanate, 2,4- and/or 2,6-tolylene diisocyanate, 1,5-naphthylene diisocyanate, 2,2′- and/or 2,4′- and/or 4,4′-diphenylmethane diisocyanate, 1,3- and/or 1,4-bis(2-isocyanato-prop-2-yl)benzene (TMXDI) and 1,3-bis(isocyanato-methyl)benzene (XDI).

In addition to the abovementioned polyisocyanates, portions of modified diisocyanates having a uretdione, isocyanurate, utrethane, allophanate, biuret, iminooxadiazinedione and/or oxadiazinetrione structure and non-modified polyisocyanate with more than 2 NCO groups per molecule, e.g. 4-isocyanatomethyl-1,8-octanediisocyante (nonanetriisocyanate) or triphenylmethane-4,4′,4″-triisocyanate, can also be used.

Preferred polyisocyanates or polyisocyanate mixtures of the abovementioned type are those which contain exclusively aliphatically and/or cycloaliphatically bound isocyanate groups and have an average NCO functionality of the mixture of 2 to 4, preferably 2 to 2,6, and particularly preferably 2 to 2,4.

Particularly preferably, hexamethylene diisocyanate, isophorone diisocyanate, the isomeric bis-(4,4′-isocyanatocyclohexyl)methanes and mixtures thereof are used in I.1).

Suitable polyols which can be used as compounds I.2) preferably have a number average molecular weight, Mn, of 400 to 8000, more preferably of 600 to 3000. The polyols have a hydroxyl number of 22 to 400 mg KOH/g, preferably 30 to 200 mg KOH/g and more preferably 40 to 160 mg KOH/g, and an OH functionality of 1.5 to 6, preferably 1.8 to 3 and more preferably 2.

Suitable polyols include the known organic polyhydroxyl compounds from polyurethane coating technology, such as polyester polyols, polyacrylate polyols, polyurethane polyols, polycarbonate polyols, polyether polyols, polyester polyacrylate polyols, polyurethane polyacrylate polyols, polyurethane polyester olyols, polyurethane polyether polyols, polyurethane polycarbonate polyols, olyester polycarbonate polyols, phenol/formaldehyde resins, and mixtures hereof.

Examples of suitable polyester polyols are the known polycondensates of diols and optionally poly(tri,tetra)ols and dicarboxylic acids and optionally poly(tri,tetra)carboxylic acids or hydroxy carboxylic acids or lactones. Instead of the free polycarboxylic acids it is also possible to use the corresponding polycarboxylic anhydrides or corresponding polycarboxylic esters of lower alcohols to prepare the polyesters. Examples of suitable diols include ethylene glycol, butylene glycol, diethylene glycol, triethylene glycol, polyalkylene glycols such as polyethylene glycol, and also propane diol, butane-1,4-diol, hexane-1,6-diol, neopentyl glycol or neopenthyl glycol hydroxypivalate, preferably one of the last three mentioned compounds. Suitable polyols include trimethylolpropane, glycerol, erythritol, pentaerythritol, triemthylolbenzene or tris-hydroxyethyl isocyanurate.

Examples of suitable dicarboxylic acids include phthalic acid, isophthalic acid, terephthalic acid, tetrahydrophthalic acid, hexahydrophthalic acid, cyclohexane-dicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid and 2,2-dimethylsuccinic acid. Anhydrides of these acids can also be used. In accordance with the present invention the anhydrides are encompassed by the expression “acid”. It is also possible to use monocarboxylic acids, such as benzoic acid and hexanecarboxylic acid, provided that the average functionality of the polyol is higher than 2. Saturated aliphatic or aromatic acids are preferred, such as adipic acid or isophthalic acid. A suitable polycarboxylic acid, which may be used in relatively small amounts, is trimellitic acid.

Suitable hydroxy carboxylic acids for preparing the polyester polyol include hydroxycaproic acid, hydroxybutyric acid, hydroxydecanoic acid and hydroxystearic acid. Lactones which can be used include caprolactone and butyrolactone.

Compounds of component I.2) may also include at least a portion of primary or secondary amino groups as NCO-reactive groups.

Also suitable as compounds I.2) are polycarbonate polyols which are obtained, for example, by reacting carbonic acid derivatives (such as diphenyl carbonate or dimethyl carbonate) or phosgene, with polyols, preferably diols. Suitable diols include ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenol A, tetrabromobisphenol A and also lactone-modified diols. The diol component preferably contains 40% to 100% by weight of hexanediol, preferably 1,6-hexanediol and/or hexanediol derivatives, preferably those which contain ether groups or ester groups as well as terminal OH groups. Examples are products obtained by reacting 1 mole of hexanediol with at least 1 mole, preferably 1 to 2 moles, of caprolactone or by etherifying hexanediol with itself to form di- or trihexylene glycol. Polyether polycarbonate diols can also be used.

The polycarbonate polyols should be substantially linear. As a result of the incorporation of polyfunctional components, however, especially low molecular weight polyols, they may optionally contain a low degree of branching. Examples of compounds suitable for this purpose include glycerol, trimethylolpropane, hexane-1,2,6-triol, butane-1,2,4-triol, trimethylolpropane, pentaerythritol, quinitol, mannitol, sorbitol, methylglycoside or 1,3,4,6-dianhydrohexitols.

Suitable polyether polyols for use as compounds I.2) are the polytetramethylene glycol polyethers known from polyurethane chemistry, which may be prepared by the polymerization of tetrahydrofuran by cationic ring opening. Also suitable are polyether polyols prepared, for example, using starter molecules, from styrene oxide, ethylene oxide, propylene oxide, butylene oxides or epichlorohydrin, preferably propylene oxide.

The low molecular weight polyols I.3) used for synthesizing the polyurethane resins generally have the effect of stiffening and/or branching the polymer chain. They preferably have a molecular weight of 62 to 200. Suitable polyols I.3) may contain aliphatic, alicyclic or aromatic groups. Examples include low molecular weight polyols having up to about 20 carbon atoms per molecule, such as ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxyphenyl)propane), hydrogenated bisphenol A (2,2-bis(4-hydroxycyclohexyl)propane), trimethylolpropane, glycerol, pentaerythritol, and mixtures of these and optionally other low molecular weight polyols I.3). Esterdiols, such as α-hydroxybutyl-ε-hydroxycaproic esters, ω-hydroxyhexyl-γ-hydroxybutyric esters, adipic acid β-hydroxyethyl esters or terephthalic acid bis(β-hydroxyethyl) esters, can also be used.

Diamines or polyamines and also hydrazides can also be used as I.3). Examples include ethylene diamine, 1,2- and 1,3-diaminopropane, 1,4-diaminobutane, 1,6-diaminohexane, isophorone diamine, an isomer mixture of 2,2,4- and 2,4,4-trimethylhexamethylene diamine, 2-methylpentamethylene diamine, diethylene triamine, 1,3- and 1,4-xylylene diamine, α,α,α′,α′-tetramethyl-1,3- and -1,4-xylylene diamine and 4,4-diaminodicyclohexylmethane, dimethylethylene diamine, hydrazine or adipic dihydrazide.

Also suitable as component I.3) are compounds which contain isocyanate-reactive groups having different reactivity towards NCO groups, such as compounds which a primary amino group and also contain secondary amino groups or contain an amino group (primary or secondary) and also contain OH groups. Examples include primary/secondary amines such as 3-amino-1-methylaminopropane, 3-amino-1-ethylaminopropane, 3-amino-1-cyclohexylaminopropane and 3-amino-1-methylaminobutane; and alkanolamines such as N-aminoethylethanolamine, ethanolamine, 3-aminopropanol and neopentanolamine, preferably dethanolamine. In the preparation of the PU dispersion of the invention they can be used as chain extenders and/or as chain terminators.

The PU dispersions of the invention may optionally contain component I.4) which results in chain termination. Suitable compounds have one isocyanate-reactive group, such as monoamines, especially mono-secondary amines, or monoalcohols. Examples include ethanol, n-butanol, ethylene glycol monobutyl ether, 2-ethylhexanol, 1-octanol, 1-dodecanol, 1-hexadecanol, methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine, suitable substituted derivatives thereof, amide amines formed from diprimary amines and monocarboxylic acids, monoketimes of diprimary amines, and primary/tertiary amines, such as N,N-dimethylaminopropylamine.

Ionic or potential ionic hydrophilic compounds I.5) include all compounds which contain at least one isocyanate-reactive group and also at least one functionality, such as —COOY, —SO₃Y, —PO(OY)₂ (wherein Y is H, NH₄⁺ or a metal cation), —NR₂, —NR₃⁺ (R═H, alkyl, aryl), which on interaction with aqueous media enters into a pH-dependent dissociation equilibrium and in that way may carry a negative, positive or neutral charge. Preferred isocyanate-reactive groups are hydroxyl or amino groups.

Suitable ionic or potential ionic hydrophilic compounds for use as component I.5) include mono- and dihydroxycarboxylic acids, mono- and diaminocarboxylic acids, mono- and dihydroxysulphonic acids, mono- and diaminosulphonic acids, mono- and dihydroxyphosphonic acids, mono- and diaminophosphonic acids, and salts of these acids. Examples include dimethylolpropionic acid, dimethylolbutyric acid, hydroxypivalic acid, N-(2-aminoethyl)-β-alanine, 2-(2-aminoethylamino)ethanesulphonic acid, ethylenediamine-propyl- or butylsulphonic acid, 1,2- or 1,3-propylenediamine-β-ethylsulphonic acid, malic acid, citric acid, glycolic acid, lactic acid, glycine, alanine, taurine, lysine, 3,5-diaminobenzoic acid, an adduct of IPDI and acrylic acid (EP-A 0 916 647, Example 1) and its alkali metal and/or ammonium salts, the adduct of sodium bisulphite with but-2-ene-1,4-diol, polyethersulphonate, and the propoxylated adduct of 2-butenediol and NaHSO₃ (described for example in DE-A 2 446 440, page 5-9, formula I-III). Also suitable are compounds which contain groups which can be converted into cationic groups, examples being amine-based units, such as N-methyldiethanolamine. It is additionally possible to use cyclohexylaminopropanesulphonic acid (CAPS) as described, for example, in WO-A 01/88006 as a compound for use as component I.5).

Preferred ionic or potential ionic compounds I.5) are those which possess carboxyl or carboxylate and/or sulphonate groups and/or ammonium groups. Particularly preferred ionic compounds I.5) are those containing carboxyl and/or sulphonate groups as ionic or potential ionic groups, such as the salts of N-(2-aminoethyl)-β-alanine, 2-(2-aminoethylamino)ethanesulphonic acid, the adduct of IPDI and acrylic acid (EP-A 0 916 647, Example 1) and dimethylolpropanionic acid.

Suitable nonionic hydrophilic compounds for use as component I.6) include polyoxyalkylene ethers which contain at least one hydroxyl or amino group. These polyethers contain a fraction of 30% to 100% by weight of units derived from ethylene oxide. Nonionic hydrophilic compounds I.6) also include monofunctional polyalkylene oxide polyether alcohols containing on average 5 to 70, preferably 7 to 55, ethylene oxide groups per molecule, which may be obtained in known manner by alkoxylating suitable starter molecules (e.g. in Ullmanns Encyclopädie der technischen Chemie, 4th edition, volume 19, Verlag Chemie, Weinheim pp. 31-38).

Examples of suitable starter molecules include saturated monoalcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols, hydroxymethylcyclohexane, 3-ethyl-3-hydroxymethyloxetane, tetrahydrofurfuryl alcohol, diethylene glycol monoalkyl ethers (such as diethylene glycol monobutyl ether), unsaturated alcohols (such as allyl alcohol, 1,1-dimethylallyl alcohol or oleyl alcohol), aromatic alcohols such as phenol, the isomeric cresols or methoxyphenols), araliphatic alcohols (such as benzyl alcohol, anisyl alcohol or cinnamyl alcohol), secondary monoamines (such as dimethylamine, diethylamine, dipropylamine, diisopropylamine, dibutylamine, bis(2-ethylhexyl)amine, N-methyl- and N-ethylcyclohexylamine or dicyclohexylamine), and heterocyclic secondary amines such as morpholine, pyrrolidine, piperidine or 1H-pyrazole. Preferred starter molecules are saturated monoalcohols. Particular preference is given to using diethylene glycol monobutyl ether as the starter molecule.

Alkylene oxides suitable for the alkoxylation reaction are preferably ethylene oxide and propylene oxide, which can be used in sequentially or in admixture in the alkoxylation reaction.

The polyalkylene oxide polyether alcohols are either pure polyethylene oxide polyethers or mixed polyalkylene oxide polyethers, wherein at least 30 mole %, preferably at least 40 mole %, of the alkylene oxide units are ethylene oxide units. Preferred nonionic compounds are monofunctional mixed polyalkylene oxide polyethers which contain at least 40 mole % of ethylene oxide units and not more than 60 mole % of propylene oxide units.

It is preferred to use 5% to 40% by weight of component I.1), 55% to 95% by weight of component I.2), 0.5 to 20% by weight of the sum of components I.3) and I.4), 0.1% to 5% by weight of component I.5), and 0 to 20% by weight of component I.6), wherein the sum of components I.5) and I.6) is being 0.1% to 25% by weight and the sum of all of the components is 100% by weight, based on the weight of components I.1) to I.6).

It is more preferred to use 5% to 35% by weight of component I.1), 60% to 90% by weight of component I.2), 0.5 to 15% by weight of the sum of components I.3) and I.4), 0.1% to 4% by weight of component I.5), and 0 to 15% by weight of component I.6), wherein the sum of components I.5) and I.6) is 0.1% to 19% by weight and the sum of all of the components is 100% by weight, based on the weight of components I.1) to I.6).

It is most preferred to use 10% to 30% by weight of component I.1), 65% to 85% by weight of component I.2), 0.5 to 14% by weight of the sum of components I.3) and I.4), 0.1% to 3.5% by weight of component I.5), and 0 to 10% by weight of component I.6), wherein the sum of components I.5) and I.6) is 0.1% to 13.5% by weight and the sum of all of the components is 100% by weight, based on the weight of components I.1) to I.6).

The process for preparing aqueous PU dispersion (I) can be carried out in one or more stages in a homogeneous phase or, in the case of a multi-stage reaction, partially in the dispersed phase. Following polyaddition of components I.1)-I.6), carried out completely or partially, there is a dispersing, emulsifying or dissolving step. Thereafter, optionally, there is a further polyaddition or modification in the dispersed phase.

To prepare the aqueous PU dispersions of the invention it is possible to use any of the known methods, such as the prepolymer mixing method, acetone method or melt dispersion method. Preferably, the PU dispersions of the invention are prepared by the acetone method.

For preparing PU dispersion (I) by the acetone method components I.2) to I.6), which should contain no primary or secondary amino groups, and polyisocyanate component I.1), which are used for preparing an isocyanate-functional polyurethane prepolymer, are usually introduced as an initial charge, in whole or in part, optionally diluted with a solvent which is miscible with water but inert towards isocyanate groups, and heated to temperatures of 50 to 120° C. To accelerate the isocyanate addition reaction it is possible to use the known catalysts from polyurethane chemistry, preferably dibutyltin dilaurate.

Suitable solvents are the known aliphatic, keto-functional solvents such as acetone or butanone which can be added not only at the beginning of the preparation but also, optionally, in portions later on. Acetone and butanone are preferred. Other solvents include xylene, toluene, cyclohexane, butyl acetate, methoxypropyl acetate, and other solvents with ether units or ester units, which may be distilled off in whole or in part, or may remain in the dispersion.

Subsequently any of components I.1)-I.6) that were not added at the beginning of the reaction are metered in.

To the prepare the polyurethane prepolymer the equivalent ratio of isocyanate groups to isocyanate-reactive groups is 1.0 to 3.5, preferably 1.1 to 3.0 and more preferably 1.1 to 2.5.

The reaction of components I.1)-I.6) to form the prepolymer takes place partially or completely, but preferably completely. In this way polyurethane prepolymers containing free isocyanate groups are obtained, in bulk (without solvent) or in solution.

The preparation of the polyurethane prepolymers is accompanied or followed, if it has not yet been carried out in the starting molecules, by the partial or complete formation of salts of the anionic and/or cationic dispersing groups. To form anionic groups, bases such as tertiary amines are used. Examples include trialkylamines having 1 to 12, preferably 1 to 6, carbon atoms in each alkyl radical, such as trimethylamine, triethylamine, methyldiethylamine, tripropylamine, N-methylmorpholine, methyldiisopropylamine, ethyldiisopropylamine and diisopropylethylamine. The alkyl radicals may also contain hydroxyl groups, as in the dialkylmonoalkanolamines, alkyldialkanolamines and trialkanolamines. As neutralizing agents it is also possible optionally to use inorganic bases, such as ammonia or sodium hydroxide and/or potassium hydroxide. Preferred are triethylamine, triethanolamine, dimethylethanolamine or diisopropylethylamine.

The molar amount of the bases 50% to 125%, preferably 70% to 100%, based on the molar amount of the anionic groups. In the case of cationic groups, dimethyl sulphate or succinic acid is used. Where only nonionic hydrophilic compounds I.6) with ether groups are used, the neutralization step is omitted. Neutralization may also take place simultaneously with dispersing, e.g., wherein the dispersing water contains the neutralizing agent.

In a further process step, if it has not yet happened or takes place only partially, the prepolymer obtained is dissolved using aliphatic ketones such as acetone or butanone. Subsequently, optionally NH₂-functional and/or NH-functional components are reacted with the remaining isocyanate groups. This chain extension/chain termination may be carried out either in solvent prior to dispersing, during dispersing, or in water after dispersing. Chain extension is preferably carried out prior to dispersing in water.

When chain extension is carried out using compounds I.5) with NH₂ groups or NH groups, the prepolymers are preferably chain extended before the dispersing operation.

The degree of chain extension, i.e., the equivalent ratio of isocyanate-reactive groups of the compounds used for chain extension to free NCO groups of the prepolymer, is 40% to 150%, preferably 50% to 120%, and more preferably 60% to 120%.

The aminic components I.3), I.4), and I.5) may optionally be used in water- or solvent-diluted form in the process of the invention, individually or in mixtures, in any sequence of addition. If water or organic solvents are used as diluents, the diluent content is preferably 70% to 95% by weight.

The preparation of the PU dispersion from the prepolymers takes place following chain extension. For that purpose the dissolved and chain-extended polyurethane prepolymer is either introduced into the dispersing water with strong shearing, such as vigorous stirring, for example, or, conversely, the dispersing water is stirred into the prepolymer solutions. Preferably, the water is introduced into the dissolved prepolymer. The solvent still present in the dispersions after the dispersing step is usually removed by distillation. Its may optionally be removed during the dispersing step.

The solids content of the PU dispersion is 50% to 70%, preferably 55% to 65% and more preferably 58% to 64% by weight.

The PU dispersions of the invention may also contain known additives such as antioxidants, light stabilizers, emulsifiers, defoamers, thickeners, fillers, plasticizers, pigments, carbon-black sols and silica sols, aluminium dispersions, clay dispersions and asbestos dispersions, flow control agents or thixotropic agents. Depending on the desired properties and intended use of the PU dispersions of the invention it is possible for up to 70%, based on the total dry matter content, of such fillers to be present in the end product.

It is also possible to modify the PU dispersions using polyacrylates. For this purpose, in the presence of the polyurethane dispersion, an emulsion polymerization of olefinically unsaturated monomers is carried out. Examples include esters of (meth)acrylic acid and alcohols having 1 to 18 carbon atoms, styrene, vinyl esters or butadiene. The modification is described, for example, in DE-A-1 953 348, EP-A-0 167 188, EP-A-0 189 945 and EP-A-0 308 115. The monomers contain one or more olefinic double bonds. In addition the monomers may contain functional groups such as hydroxyl, epoxy, methylol or acetoacetoxy groups.

When using the PU dispersions as coating compositions, they are either used alone or in combination with other aqueous binders. Suitable aqueous binders include polyester, polyacrylate, polyepoxide or polyurethane polymers. The PU dispersions may also be used in combination with radiation-curable binders, such as those described, for example, in EP-A-0 753 531. It is also possible to blend the PU dispersions of the invention with other anionic or nonionic dispersions, such as polyvinyl acetate, polyethylene, polystyrene, polybutadiene, polyvinyl chloride, polyacrylate and copolymer dispersions.

The polyurethane-polyurea dispersions of the invention are also suitable for preparing aqueous sizing systems or adhesive systems.

Examples of suitable substrates include woven and non-woven textiles, leather, paper, hard fiber, straw, paper-like materials, wood, glass, plastics, ceramic, stone, concrete, bitumen, porcelain, metals or glass fibers. Preferred substrates are textiles, leather, plastics, metallic substrates or mineral substrates, more preferably textiles and leather.

The PU dispersions of the invention are stable, storable and transportable and can be processed at any desired subsequent time. They can be cured at relatively low temperatures of 120 to 150° C. within 2 to 3 minutes to give coatings which have, in particular, very good wet bond strengths.

Depending on the selected chemical composition and urethane group content, coatings having different properties are obtained. Thus it is possible to obtain soft tacky coats, thermoplastic and rubber-elastic products having varying degrees of hardness, up to and including glass-hard thermosets. The hydrophilicity of the products may also fluctuate within certain limits. The elastic products can be processed thermoplastically at relatively high temperatures of 100 to 180° C., if they have not been chemically crosslinked.

Due to their excellent foamability and their good abrasion resistance, scratch resistance, crease resistance and resistance to hydrolysis, the PU dispersions of the invention are particularly suitable for applications in the fields of upholstered furniture, workplace protection and automotive interior equipment, and also for producing very stable, high foam layers in only one coat, which are otherwise obtainable only with solvent-borne high solids coating compositions.

The present invention also relates to the use of the PU dispersions in the fields of upholstered furniture, workplace protection and automotive interior equipment and also for producing high foam layers in only one coat.

### EXAMPLES

Unless indicated otherwise, all percentages are to be understood as being percents by weight.

Constituents and Abbreviations Used:

Diaminosulphonate: NH₂—CH₂CH₂—NH—CH₂CH₂—SO₃Na (45% in water)

The solids contents were determined in accordance with DIN EN ISO 3251.

NCO contents, unless expressly mentioned otherwise, were determined volumetrically in accordance with DIN EN ISO 11909.

The properties of PU dispersions were determined on free films produced as follows:

A film applicator containing two polished rolls, which can be set an exact distance apart, has a release paper inserted into it ahead of the back roll. The distance between the paper and the front roll was adjusted using a feeler gauge. This distance corresponded to the film thickness (wet) of the resulting coating, and was adjusted to the desired add-on of each coat. Coating can also be carried out consecutively in two or more coats.

When applying the individual coats the products (aqueous formulations were adjusted beforehand to a viscosity of 4500 mPa·s by the addition of ammonia/polyacrylic acid) were poured onto the nip between the paper and the front roll, the release paper was pulled away vertically downwards, and the corresponding film was formed on the paper. When two or more coats were applied, each individual coat was dried and the paper was reinserted.

The modulus at 100% elongation was determined in accordance with DIN 53504 on films >100 μm thick.

The average particle sizes (the figure reported is the number average) of the PU dispersions were determined by means of laser correlation spectroscopy (instrument: Malvern Zetasizer 1000, Malvern Instr. Limited).

The particle size distributions were determined by the method of analytical ultracentrifugation, which is described in the following literature:
1. W. Scholtan, H. Lange, Kolloid-Z. u. Z. Polymere 250 (1972) 782
2. H. G. Müller, Colloid Polym. Sci. 267 (1989) 1113
The distributions obtained were mass distributions.

The charge ratios of the dispersions were determined by conductometric titration. A dispersion diluted with water was acidified with HCI (c(HCI) typically 0.1 N) (to a pH of approximately 3; this was usually achieved by an addition of 2.5 ml of 0.1 N hydrochloric acid) and titrated with NaOH (c(NaOH) typically 0.05 N, not more than 10 mL) following addition of a nonionic stabilizer (5% Brij 96 solution) (titrator: Mettler DL21, sample changer: Mettler Rondo 80, volume to be titrated: 80-90 mL).

The conductivity determined during the titration and the pH (pH electrode: Schott H61, conductivity electrode: WTW LTA/KS) produced a characteristic curve from which it was possible to calculate the degree of dissociation as a function of pH. Titration took place of the acid groups employed and the neutralizing agent employed (in this case DMEA) and other weakly acidic and basic groups that were formed during dispersion preparation. The groups determined were located on the particle surface or in the liquid phase; “hidden” charges, in the interior of the particle, were not titrated. The amount of charge of the dispersion, determined in this way, was referred to as total charge in the results shown at the front. When the dispersions were treated with an ion exchanger prior to titration, the charge groups were separated off in the liquid phase. Conductometric titration then provided the amount of weakly acidic and basic groups on the particle surface (known as surface charge).

The viscosities were determined in accordance with DIN EN ISO 3219/A3 at a temperature of 23° C.

### Example 1: Comparative Example, PU Dispersion (Component I)

Impranil® DLN: an anionic hydrophilic monomodal PU dispersions based on polyester, having a solids content of 40% and an average particle size of 100-300 nm, Bayer AG, Leverkusen, DE.

### Example 2

2210.0 g of a difunctional polyester polyol prepared from adipic acid, neopentyl glycol and hexanediol (number average molecular weight 1700 g/mol, OH no. 66) were heated to 65° C. Subsequently, at 65° C., over the course of 5 minutes, a mixture of 195.5 g of hexamethylene diisocyanate and 258.3 g of isophorone diisocyanate was added and the mixture was stirred at 100° C. until the theoretical NCO content of 3.24% was reached. The finished prepolymer was dissolved with 4800 g of acetone at 50° C. and then a solution of 29.7 g of ethylene diamine, 95.7 g of diaminosulphonate and 602 g of water was metered in over the course of 5 minutes. The subsequent stirring time was 15 minutes. Thereafter, over the course of 20 minutes, dispersion took place by the addition of 1169 g of water. This was followed by removal of the solvent by vacuum distillation, to give a storage stable bimodal PU dispersion having a solids content of 60%. The solids fraction of the dispersion was composed of 31% of a fine fraction and 69% of a coarse fraction. The maximum of the fine fraction in the particle size distribution was 59 nm; the maximum of the coarse fraction was 385 nm. The dispersion particles of the fine fraction had particle sizes between 20 nm and 160 nm. The particles of the coarse fraction had particle sizes between 175 nm and 625 nm. The viscosity of the dispersion was 196 mPa·s.

The dispersion was separated by ultracentrifugation into a coarse fraction and a fine fraction. The total surface charge of the fine fraction was 77 μeq/g resin solids. The total surface charge of the coarse fraction was 35 μeq/g resin solids.

### Example 3

500.0 g of a difunctional polyester polyol prepared from phthalic acid and 1,6-hexanediol (number average molecular weight 2000 g/mol, OH no. 56) were heated to 65° C. Subsequently, at 65° C., over the course of 5 minutes, a mixture of 37.6 g of hexamethylene diisocyanate and 49.7 g of isophorone diisocyanate was added and the mixture was stirred at 100° C. until the theoretical NCO content of 2.82% was reached. The finished prepolymer was dissolved with 1060 g of acetone at 50° C. and then a solution of 4.4 g of ethylenediamine, 27.6 g of diaminosulphonate and 136.3 g of water was metered in over the course of 5 minutes. The subsequent stirring time was 15 minutes. Thereafter, over the course of 20 minutes, dispersion took place by the addition of 251.2 g of water. This was followed by removal of the solvent by vacuum distillation, to give a storage stable bimodal PU dispersion having a solids content of 59.8%. The solids fraction of the dispersion was composed of 35% of a fine fraction and 65% of a coarse fraction. The maximum of the fine fraction in the particle size distribution was 133 nm; the maximum of the coarse fraction was 675 nm. The dispersion particles of the fine fraction had particle sizes between 50 nm and 250 nm. The particles of the coarse fraction had particle sizes between 300 nm and 1000 nm. The viscosity of the dispersion was 119 mPa·s.

The dispersion was separated by ultracentrifugation into a coarse fraction and a fine fraction. The total surface charge of the fine fraction was 120 μeq/g resin solids. The total surface charge of the coarse fraction was 80 μeq/g resin solids.

### Example 4

2159.6 g of a difunctional polyester polyol prepared from adipic acid, neopentyl glycol and hexanediol (number average molecular weight 1700 g/mol, OH no. 66) and 72.9 g of a monofunctional polyether based on ethylene oxide/propylene oxide (70/30) (number average molecular weight 2250 g/mol, OH number 25 mg KOH/g) were heated to 65° C. Subsequently, at 65° C., over the course of 5 minutes, a mixture of 241.8 g of hexamethylene diisocyanate and 320.1 g of isophorone diisocyanate was added and the mixture was stirred at 100° C. until the theoretical NCO content of 4.79% was reached. The finished prepolymer was dissolved with 4990 g of acetone at 50° C. and then a solution of 187.1 g of isophoronediamine and 322.7 g of acetone was metered in over the course of 2 minutes. The subsequent stirring time was 5 minutes. Thereafter, over the course of 5 minutes, a solution of 63.6 g of diaminosulphonate, 6.5 g of hydrazine hydrate and 331.7 g of water was metered in. Dispersing took place by the addition of 1640.4 g of water. This was followed by removal of the solvent by vacuum distillation to give a storage stable bimodal PU dispersion having a solids content of 58.9%. The solids fraction of the dispersion was composed of 36% of a fine fraction and 64% of a coarse fraction. The maximum of the fine fraction in the particle size distribution was 65 nm; the maximum of the coarse fraction was 415 nm. The dispersion particles of the fine fraction had particle sizes between 20 nm and 175 nm. The particles of the coarse fraction had particle sizes between 200 nm and 800 nm. The viscosity of the dispersion was 32 mPa·s.

The dispersion was separated by ultracentrifugation into a coarse fraction and a fine fraction. The total surface charge of the fine fraction was 83 μeq/g resin solids. The total surface charge of the coarse fraction was 23 μeq/g resin solids.

### Example 5

2100.0 g of a difunctional polycarbonate polyol prepared from 1,6-hexanediol (number average molecular weight 2000 g/mol, OH no. 56) and 84.4 g of a monofunctional polyether prepared from ethylene oxide/propylene oxide (70/30) (number average molecular weight 2250 g/mol, OH number 25 mg KOH/g), 55.4 g of neopentyl glycol and 36.7 g of dimethylolpropionic acid were heated to 75° C. Subsequently, at 75° C., over the course of 5 minutes, a mixture of 636.2 g of Desmodur W and 106.1 g of isophorone diisocyanate was added and the mixture was stirred at 100° C. until the theoretical NCO content of 2.9% was reached. The finished prepolymer was dissolved with 5360 g of acetone at 50° C. and neutralized with 27.0 g of triethylamine. Subsequently, a solution of 22.6 g of diethylenetriamine, 23.9 g of hydrazine hydrate and 166 g of water was metered in over the course of 5 minutes. The subsequent stirring time was 15 minutes. Dispersing took place by the addition of 1863 g of water over the course of 20 minutes. This was followed by removal of the solvent by vacuum distillation, to give a storage stable bimodal PU dispersion having a solids content of 60.1%. The solids fraction of the dispersion was composed of 33% of a fine fraction and 67% of a coarse fraction. The maximum of the fine fraction in the particle size distribution was 63 nm; the maximum of the coarse fraction was 493 nm. The dispersion particles of the fine fraction had particle sizes between 10 nm and 200 nm. The particles of the coarse fraction had particle sizes between 200 nm and 1000 nm. The viscosity of the dispersion was 266 mPa·s.

The dispersion was separated by ultracentrifugation into a coarse fraction and a fine fraction. The total surface charge of the fine fraction was 360 μeq/g resin solids. The total surface charge of the coarse fraction was 30 μeq/g resin solids.

TABLE 1
Mechanical properties

| | 100% | Tensile | Breaking |
|---|---|---|---|
| | modulus | strength | elongation |
| Example | [MPa] | [MPa] | [%] |
| 1 (comparative) | 2.0 | 20 | 700 |
| 2 (inventive) | 1.0 | 14 | 1300 |
| 3 (inventive) | 1.2 | 13 | 1200 |
| 4 (inventive) | 3.0 | 26 | 1300 |
| 5 (inventive) | 4.3 | 43 | 660 |

Based on the data set forth in Table 1, the coatings produced from the PU dispersions of the invention exhibit improved mechanical properties when compared with the prior art coatings.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An aqueous polyurethane-polyurea dispersion having two discrete maxima in the particle size distribution, characterized in that the maximum of the fine fraction is between 51 and 150 nm and the maximum of the coarse fraction is between 160 and 700 nm.

2. The aqueous polyurethane-polyurea dispersion of claim 1 wherein the polyurethane particles of the fine fraction have a particle size between 5 and 300 nm.

3. The aqueous polyurethane-polyurea dispersion of claim 1 wherein the polyurethane particles of the fine fraction have a particle size between 10 and 275 nm.

4. The aqueous polyurethane-polyurea dispersion of claim 1 wherein the polyurethane particles of the coarse fraction have a particle size between 125 and 1250 nm.

5. The aqueous polyurethane-polyurea dispersion of claim 1 wherein the polyurethane particles of the coarse fraction have a particle size between 160 and 1000 nm.

6. The aqueous polyurethane-polyurea dispersion of claim 1 wherein the dispersion contains 10 to 50% by weight of a fine fraction 50 to 90% by weight of a coarse fraction, wherein the sum of the weight fractions of the fine fraction and the coarse fraction add up to 100% by weight.

7. The aqueous polyurethane-polyurea dispersion of claim 1 wherein the solids content is between 50% and 70% by weight.

8. The aqueous polyurethane-polyurea dispersion of claim 1 wherein the solids content is between 55% and 65% by weight.

9. The aqueous polyurethane-polyurea dispersion of claim 1 wherein the viscosity is 1 to 1500 mPa·s.

10. The aqueous polyurethane-polyurea dispersion of claim 1 wherein the dispersion does not contain an external emulsifier.

11. A process for preparing the polyurethane-polyurea dispersion of claim 1 which comprises reacting at an equivalent ratio of isocyanate groups to isocyanate-reactive groups of 1.0 to 3.5, components selected from
I.1) polyisocyanates,
I.2) polyols having number average molecular weights of 200 to 8000 g/mol,
I.3) low molecular weight compounds having a number average molecular weight of 62 to 400 and containing in total two or more hydroxyl and/or amino groups,
I.4) compounds containing one hydroxyl or amino group,
I.5) isocyanate-reactive, ionic or potential ionic hydrophilic compounds, and
I.6) isocyanate-reactive, nonionic hydrophilic compounds,
to form an isocyanate-functional prepolymer free of urea groups, and subsequently reacting the remaining isocyanate groups with chain extension or chain termination before, during or after dispersing in water, wherein the amount of ═N⁺═, ═S⁺—, —COO— or —SO₃⁻ or PO₃²⁻ groups is 0.1 to 15 milliequivalent per 100 g of resin solids, with amino-functional compounds selected from I.3) to I.6) at an equivalent ratio of amino groups to free isocyanate groups of 40% to 150%.

12. A coating composition comprising the polyurethane-polyurea dispersion of claim 1.

13. A coated substrate prepared from the coating composition of claim 12.

14. The coated substrate of claim 13 wherein the substrate is a textile or leather.
